(19) United States
(12) Patent Application Publication
(10) Pub. No.: US 2020/0394734 A1
(43) Pub. Date: Dec. 17, 2020

(54) System and Method for Generating Legal Contracts

(71) Applicants: William Robert Moriarty, Pasadena, CA (US); Gina Pak, Pasadena, CA (US); Andrew Wells, Dallas, TX (US); Scott Tamura, Gardena, CA (US)

(72) Inventors: William Robert Moriarty, Pasadena, CA (US); Gina Pak, Pasadena, CA (US); Andrew Wells, Dallas, TX (US); Scott Tamura, Gardena, CA (US)

(21) Appl. No.: 16/900,957

(22) Filed: Jun. 14, 2020

Related U.S. Application Data
(60) Provisional application No. 62/861,790, filed on Jun. 14, 2019.

(51) Int. Cl. G06Q 50/18; G06Q 10/10; G06Q 30/02; G06N 20/00; G06N 5/04

(52) U.S. Cl. CPC G06Q 50/184; G06Q 10/10; G06Q 30/0205; G06F 3/04842; G06N 20/00; G06N 5/04; G06Q 50/182

(57) ABSTRACT

A machine-learning-based method for analyzing, negotiating, and drafting contracts that provides the user with information regarding market terms for particular industries and geographic locations.

### CROSS-REFERENCE TO RELATED APPLICATIONS

The present application takes priority from Provisional App. No. 62/861,790, filed Jun. 14, 2019, which is incorporated herein by reference.

### BACKGROUND

### Field of the Invention

The present invention relates generally to systems, methods, and software for generating and reviewing documents, and specifically to systems, methods, and software for generating and reviewing legal contracts.

### Background of the Invention

A large part of a legal professional's work is generating, reviewing and negotiating transactional documents such as contracts. Typically, a contract includes many provisions that may favor one side over another, and lawyers for each side must recognize, understand, and negotiate each provision during the negotiation process for the agreement. This is often a cumbersome process and requires extensive expertise and resources.

Existing document automation systems can elicit data from a user to generate a document. For example, a user can select the type of document, enter the names of the parties, and enter some other types of data, and generate a document of the desired type based on the user inputs.

Some document automation systems can use rules to generate documents based on the input data; for example, a party that is a corporation may be treated differently from a party who is a natural person, and the contract may be worded differently depending on the nature of the party. Another example would be using an iterative process to generate a list of parties, or to insert a particular phrase repeatedly for each party in a contract.

One thing that existing document automation systems do not do, however, is provide a user with any guidance about the way things are typically done in a particular industry or a particular type of agreement or for a particular type of party. While an experienced contract drafter may be aware of common industry practices in their industry, a novice may not be, and the novice may find themselves at a disadvantage during negotiations because of that.

Another thing that existing document automation systems do not do is provide a user with guidance as to clause language that is more or less favorable to a particular party. For example, during negotiations, a contract drafter may want to alter the language of a clause to make it more favorable to a particular party. Existing document automation systems do not determine the favorability of a clause, and thus would not be able to determine how to change a clause to make it more favorable.

A need exists for a document automation system that can provide a user with guidance based on common practices in a particular market, and with information regarding the favorability of a particular clause.

### LIST OF FIGURES

FIG. 1 shows a diagram of an embodiment of the system of the present invention.

FIG. 2 shows a flowchart of an embodiment of the method of the present invention.

FIG. 3 shows a sample screenshot from an embodiment of the present invention.

FIG. 4A shows a sample screenshot from an embodiment of the present invention.

FIG. 4B shows a sample screenshot from an embodiment of the present invention.

FIG. 5A shows a sample screenshot from an embodiment of the present invention.

FIG. 5B shows a sample screenshot from an embodiment of the present invention.

FIG. 5C shows a sample screenshot from an embodiment of the present invention.

FIG. 5D shows a sample screenshot from an embodiment of the present invention.

### SUMMARY OF THE INVENTION

An object of the present invention is to provide a system and method for analyzing, generating, and negotiating contracts.

Another object of the present invention is to use machine learning to analyze, generate, and negotiate contracts.

Another object of the present invention is to identify and collect data from user inputs related to contract type, industry, compensation, duties, and favorability, and to use the collected data to augment and improve the machine learning models.

Another object of the present invention is to identify and collect data from user inputs related to contract type, industry, compensation, duties, and favorability, and to use the collected data to provide a user with guidance regarding common practices in the particular contract type, industry, or for a particular type of party.

Another object of the present invention is to provide a system and method for adjusting the favorability of a particular provision of a contract.

An aspect of the present invention is a method for generating legal documents comprising at least one clause. Such legal documents may be contracts or other transactional documents. The method may include selecting a legal document type, selecting at least one parameter, such as client industry, geographic location, client's point of view, and automatically generating a legal document using the at least one parameter; then, displaying the legal document on a display device and presenting the user with a selection interface wherein a user can select alternative versions of at least one particular clause. The selection interface presents the user with information on the legal impact of each alternative version, such as the favorability of the version to a given party, and with recommendations based on common practices in that particular industry, contract type, or for this particular type of party.

In an aspect of the invention, the user's selections are recorded, aggregated with other users' selections, and anonymized, and used to generate statistical data related to common practices in the particular industry, contract type, or type of party. The statistical data is then used to generate recommendations to subsequent users.

In an aspect of the invention, the selection interface provides the user with at least two versions of a clause and information on the favorability of each of these versions to a party.

Variations in these and other aspects will be described in additional detail hereafter.

### DETAILED DESCRIPTION OF EXEMPLARY EMBODIMENTS

Before embodiments of the present invention are described in detail, it is to be understood that the description is not meant to be limiting, and that the invention is not limited in its application to the details of the construction and components set forth in the description or illustrated in the drawings. It is also to be understood that the phraseology and terminology used herein is for the purposes of description and not meant to be limiting.

While the following detailed description discloses the application of the present invention to drafting legal contracts and agreements, and refers to clauses of said contracts, the present invention may be used for other standardized documents comprising multiple clauses where information from multiple users may be aggregated to give a subsequent user guidance on how the document is to be drafted.

Overview of the System

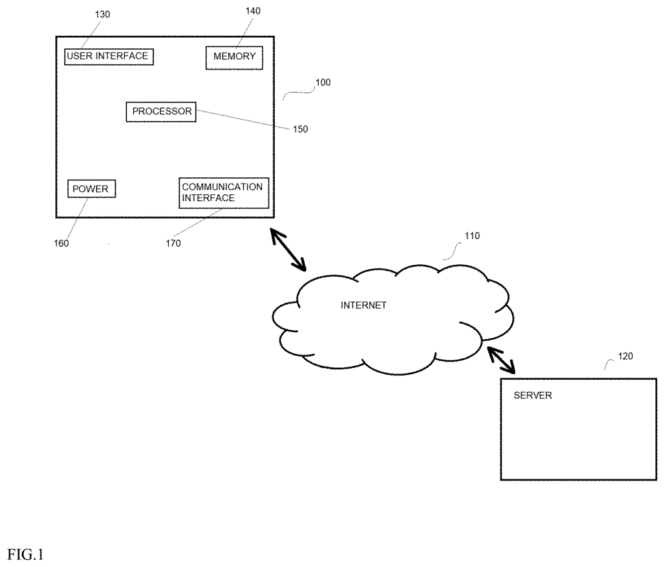

The present invention is implemented on a computing device. FIG. 1 shows a computing device 100 in accordance with an aspect of the present invention. The computing device 100 preferably comprises a processor, a memory, a communication interface, a user interface, and a power supply. The communication interface is preferably connected to a server 120 by means of the Internet 110 or some other data/communications network. The computing device can be a computer, a tablet, a smartphone, or any other device that can execute the methods of the present invention.

Workflow

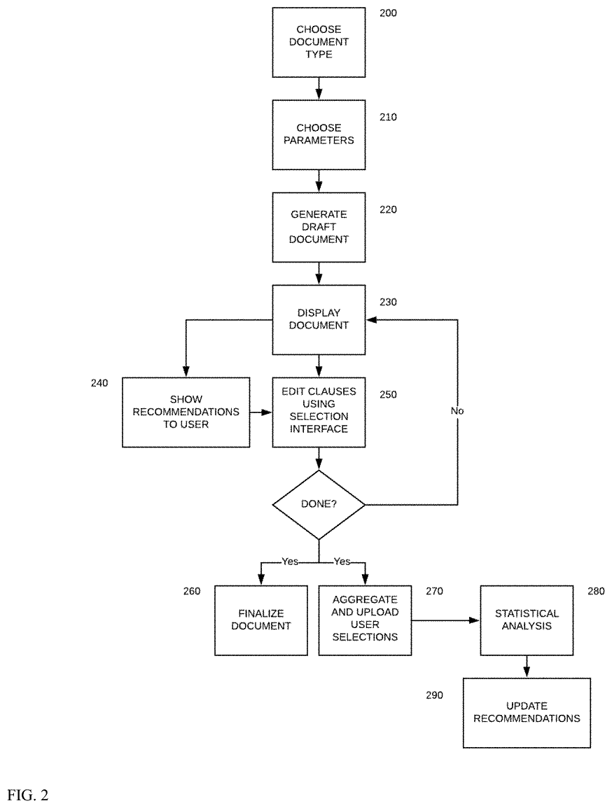

FIG. 2 shows a flowchart illustrating processes performed in accordance with an embodiment of the present invention. A user first chooses a document type 200. For example, a document type may be a services agreement, a nondisclosure agreement, a statement of work, a privacy policy, a nondisclosure agreement, terms of use, employee offer letter, employment agreement, licensing agreement, LLC operating agreement, or any other contract or agreement. The document may involve only a single party (i.e. a nondisclosure agreement), or two or more parties (i.e. a services agreement between a service provider and a client). It is to be understood that the document type is not limited to the types disclosed above, but may be any standardized document comprising multiple clauses.

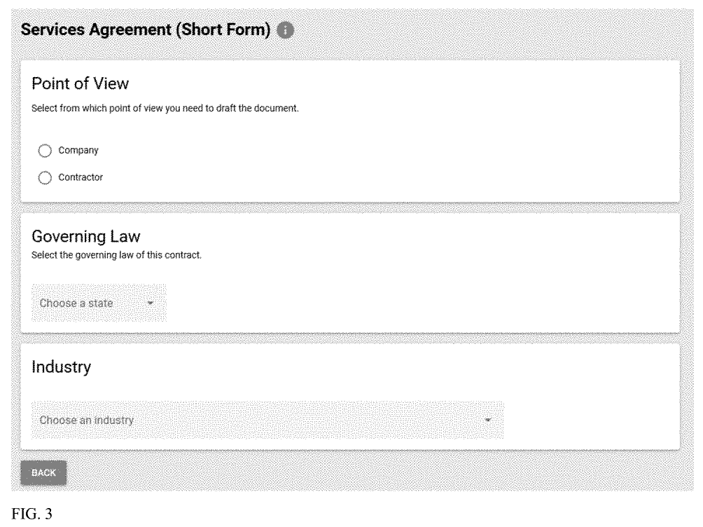

After the user selects the document type, they then choose the parameters 210 for that document. In an embodiment, the parameters may be the client industry, geographical location, the point of view (i.e. service provider or client), or any other parameters affecting the document. FIG. 3 shows a screenshot of the embodiment of the present invention where the user is prompted to choose the parameters.

A draft document is then generated 220 based on the parameters entered by the user, and displayed for the user 230. Each clause of the document is presented in an editable interface.

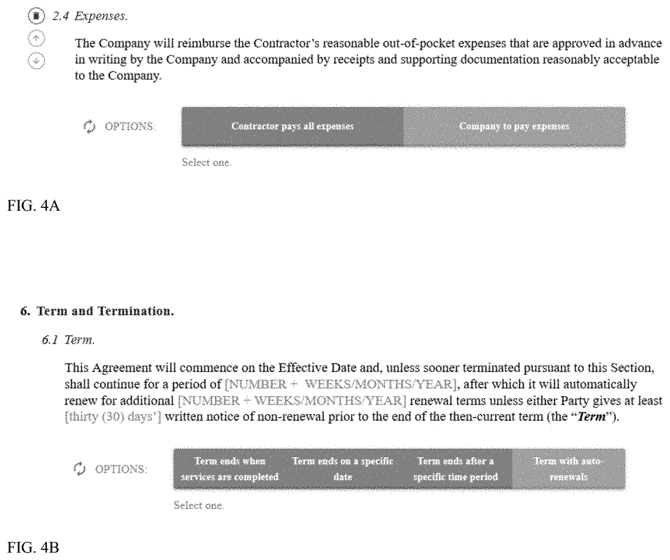

In an embodiment, a clause may be editable by clicking a button. FIGS. 4A and 4B show examples of buttons that can adjust the form of a clause from one option to another. For example, FIG. 4A shows a clause regarding a contractor's expenses. A user may choose between “Contractor pays all expenses” and “Company to pay expenses”. Clicking each button will change the text of the clause in accordance with the button.

In an embodiment, a clause may be editable both by clicking a button and by entering text. FIG. 4B shows a clause regarding the term of an agreement. A user may choose four options for the term, and enter text directly into the clause as well, as shown in the Figure.

It will be understood that any number of buttons may be used to practice the present invention, and that any clause may be edited by means of buttons as shown.

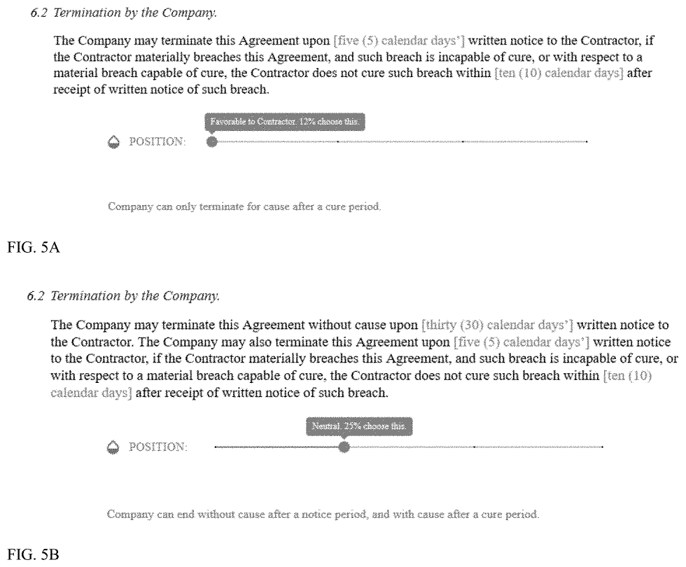

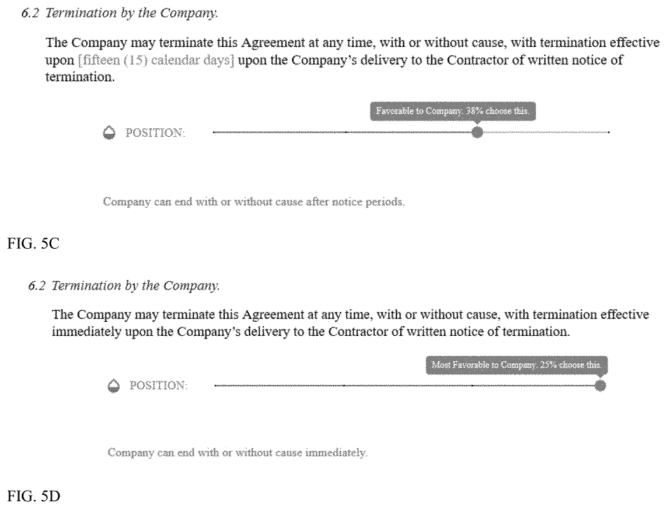

In an embodiment, a clause may be editable by sliding a slider. Some clauses in a legal document are more favorable to one party than another, and the exact form of these clauses is the subject of much negotiation. The present invention offers a user an easy way to adjust the favorability of various clauses using a selection interface. FIGS. 5A-5D show four versions of a termination clause, in order from the most favorable to the contractor (FIG. 5A), to the most favorable to the company (FIG. 5D). It will be understood that any number of versions of a particular clause may be used with the present invention.

As can be seen in FIGS. 5A-5D, the present invention also offers guidance to a user on the percentage of all users that select each option, and shows recommendations 240 to the user during the editing process. The statistics are generated by the system from aggregating the selections made by multiple prior users, and presented to the user to inform their choice. A user is then able to make an informed choice in line with common practices.

As can be seen in FIGS. 5A-5D, one other way the present invention offers guidance to the user is by explaining what the legal impact of each clause is. For example, FIG. 5A offers an explanation of the clause under the slider as “Company can only terminate for cause after a cure period.” Each one of FIGS. 5B, 5C, and 5D also offer explanations of each version of the clause. This further helps guide the user into making informed choices on behalf of their client.

If a user is done, the document is finalized 260. The user's selections (the buttons the user clicked, numerical values that are entered, or slider positions for favorability) are anonymized, aggregated, and uploaded to the server 120. The server then performs a statistical analysis 280 on the aggregated data and updates the recommendations 290 for subsequent users.

Market Standards and Recommendations

As can be seen in FIGS. 5A-5D, the user is presented with information regarding best practices and market standards related to the particular type of clause and particular type of contract. In the presently described embodiment, for each position of the slider, the user is presented with the percentage of all users that choose that position. For example, in FIG. 5A, the user is informed that 12% choose the position selected in the Figure; in FIG. 5B, the user is informed that 25% choose the position selected; in FIG. 5C, the user is informed that 38% choose the position selected; and in FIG. 5D, the user is informed that 25% choose the position selected. The information is generated by aggregating and analyzing selections made by other users, or other selections made by the same user.

In an aspect of the present invention, contracts are grouped by industry, type of contract, client POV, client's industry, and/or geographical location. The statistical analysis is then performed for each group, so that the recommendations to the user can come from an analysis of the same type of contract as the one the user is drafting, in the same geographical area and industry that the user is in. Since standards differ by industry and geographical area, this is very helpful for a user and provides useful information. For example, the statistical analysis may determine what percentage of indemnification clauses in the food processing industry in California favor the contractor over the corporation, or what the typical royalty rate is for a patent licensing agreement in Nevada in the gambling industry.

In an aspect of the present invention, as the user makes certain selections for different clauses (i.e. using the buttons or the sliders to pick particular versions of given clauses, making in document substantive edits, or filling in data for durations or fees or other alphanumerical information), the user's selections are recorded and a pattern is generated. The pattern can comprise user selections or alphanumerical values. The pattern may be plaintext or assigned weighted number or symbol, and may be in any other format that can represent the information required. In an aspect of the present invention, the pattern may be displayed to the user.

The pattern for the user is then uploaded to a server 120 via the Internet 110 or another communication interface, as shown in FIG. 1. The pattern is aggregated 270 with other patterns uploaded by other users. A statistical analysis 280 is then performed on the patterns.

The statistical analysis is preferably geared to determine market standards for particular contract clauses for particular types of contracts, particular industries, and particular geographic areas, and may include contract type, client POV, clause type, industry, geographic location, or any combination of the above variables.

After the statistical analysis is performed, the data is then used to make recommendations 290 for a future user. For example, a user who is generating a contract in a particular industry and a particular geographical location will get recommendations based on what other users in the same industry and the same geographical locations have selected (i.e. “92% of users in Nevada who are generating a casino employment agreement have selected an indemnification clause that favors the employer”). The recommendations may be triggered to pop up at the time when a user is editing or generating a particular clause of the contract, may be summarized for the user when the user selects the type of contract, industry, and geographical location, or may be presented to the user after they make their selections, before they finalize the contract.

In an embodiment, the system of the present invention is a machine learning system. The system preferably comprises a hierarchical system of using artificial neural networks including, but not limited to, convolutional neural networks (CNN's), recurrent neural networks (RNNs), Long term short-memory RNNs (LSTMs), and machine learning models including but not limited to statistical probability models, linear regression models, clustering, naive Bayesian, support-vector models (svg) models trained using a feedback loop of supervised learning and rule-based pattern matching, and any reasonable equivalents to the above. The system may also use supervised learning, which consists of presenting the model with pre-labeled data to build a feature space representation. The final platform output preferably consists of multiple classifications including document type, clause classification, and clause favorability.

An exemplary embodiment is described above. It will be understood that the present invention encompasses other embodiments whose elements form reasonable equivalents to the embodiments described above.

1. A method for generating legal documents comprising at least one clause, comprising:
selecting a legal document type out of at least two types of legal documents;
selecting at least one parameter for the legal document;
automatically generating a legal document using the at least one parameter;
displaying the legal document on a display device;
for at least one clause, presenting a selection interface wherein a user can select at least one alternative version of the clause, wherein the selection interface presents the user with information on a legal impact of each alternative version and statistical data on selections made by a plurality of users;
generating a final version of the legal document based on user selections;
downloading the final version of the legal document;
aggregating the selections made by the user and adding them to the statistical data.

2. The method of claim 1, wherein the at least one parameter is selected from a list comprising: client industry, client's geographic location, client's point of view.

3. The method of claim 1, wherein the legal document is a transactional document between at least two parties, wherein the legal impact of each alternative version comprises a favorability of each clause to a party.

4. The method of claim 1, wherein the statistical data comprises:
popular selections in a particular market, wherein the market comprises at least one of:
particular contract types, client's industry, client's geographic location.

5. The method of claim 1, wherein the selection interface comprises an interactive slider.

6. The method of claim 1, wherein the legal document comprises at least one structural clause, further comprising:
for at least one structural clause, presenting a second selection interface wherein a user can select at least one data value to input into the structural clause.

7. The method of claim 6, wherein the at least one data value is selected from a group comprising: term, termination date, acceptance testing, non-solicitation, fees, IP ownership, expenses, jurisdiction, dispute resolution, confidentiality definition.

8. The method of claim 6, wherein the second selection interface is an interactive button.

9. The method of claim 1, wherein the statistical data comprises recommendations to the user.

10. The method of claim 9, wherein the recommendations to the user are generated using machine learning algorithms.

11. A system for generating a legal document comprising at least one clause, comprising:
a processor;
a display device;
a user interface;
a memory, wherein the memory includes instructions executable by the processor to:
select a legal document type out of at least two types of legal documents;
select at least one parameter for the legal document;
automatically generate a legal document using the at least one parameter;
display the legal document on the display device;
for at least one clause, present a selection interface wherein a user can select at least one alternative version of the clause with the user interface, wherein the selection interface presents the user with information on a legal impact of each alternative version and statistical data on selections made by a plurality of users;
generate a final version of the legal document based on user selections;
download the final version of the legal document;
aggregate the selections made by the user and add them to the statistical data.

12. The system of claim 11, further comprising:
a communication interface;
a server;
wherein the statistical data is stored on the server and transmitted to the processor via the communication interface.

13. The system of claim 11, wherein the at least one parameter is selected from a list comprising: client industry, client's geographic location, client's point of view.

14. The system of claim 11, wherein the legal document is a transactional document between at least two parties, wherein the legal impact of each alternative version comprises a favorability of each clause to a party.

15. The system of claim 11, wherein the statistical data comprises:
popular selections in a particular market, wherein the market comprises at least one of:
particular contract types, client's industry, client's geographic location.

16. The system of claim 11, wherein the selection interface comprises an interactive slider.

17. The system of claim 1, wherein the legal document comprises at least one structural clause, further comprising a second selection interface wherein a user can select at least one data value to input into the structural clause.

18. The system of claim 17, wherein the second selection interface is an interactive button.

19. The system of claim 11, wherein the statistical data comprises recommendations to the user.

20. The system of claim 19, wherein the recommendations to the user are generated using machine learning algorithms.
